(19) United States
(12) Patent Application Publication
(10) Pub. No.: US 2023/0086558 A1
(43) Pub. Date: Mar. 23, 2023

(54) Panoptes Device or Image Acquisition System Having Multiple Independent Sensors

(71) Applicant: Storevision North America, Inc., Bridgeport, PA (US)

(72) Inventor: Barry Katz, Bridgeport, PA (US)

(73) Assignee: Storevision North America, Inc., Bridgeport, PA (US)

(21) Appl. No.: 17/989,904

(22) Filed: Nov. 18, 2022

Related U.S. Application Data
(63) Continuation-in-part of application No. 16/972,665, filed on Dec. 7, 2020, now Pat. No. 11,545,021.
(60) Provisional application No. 62/682,258, filed on Jun. 8, 2018.

(51) Int. Cl. H04N 23/80; H04N 7/18; H04N 23/90

(52) U.S. Cl. CPC H04N 23/80; H04N 7/181; H04N 23/90

(57) ABSTRACT

An acquisition imaging system is described herein that acquires multiple images from multiple imagers where each are sent to a single processor/controller, resulting in a single, resultant image providing a detailed field of view. The system is comprised of multiple sets of images taken by multiple sensors, strategically placed to acquire multiple perspectives of an image field. Each sensor is packaged with digitization, compression and communication components in an imager to allow for the transfer of the image to a processor/controller system controller. PanOpts supports multiple processors and controllers configurations as well. The system’s controller acts as the network interface, power supply and centralized management for processing information, specifically the analytics. The present invention has applications in surveillance, event classification systems, indexed archival storage, real-time and post facto image content analytics, future filtering vectors; ad hoc querying, automatic queries, and multiple query languages.

### CROSS REFERENCE TO RELATED APPLICATIONS

This application is a continuation-in-part of U.S. National Application 16/972,665, filed on 07 Dec. 2020, now allowed, which is the U.S. National Phase Application of PCT/US2019/035969, filed on 07 Jun. 2019, now expired, and which claims priority to U.S. Provisional Application No. 62/682,258, filed on 08 Jun. 2018, now expired, the disclosures of which are herein incorporated by reference in its entirety.

### BACKGROUND OF THE INVENTION

### 1. Field of the Invention

The present invention relates to imaging devices or more specifically the acquisition, transmission and processing of images collected from multiple sensors.

### 2. Description of the Prior Art

Recently, extensive research has been conducted on the acquisition and analysis of complementary imaging using two or more sensors to improve the accuracy and reliability of image processing, such as change detection, motion detection, super-resolution image restoration and object recognition/tracking, which are used in many technical applications such as monitoring, surveillance, traffic, inventory, process, and medical imaging systems.

Conventional approaches for acquiring multiple images incorporate a multi-camera system which is mounted with multiple cameras in an integrated manner such that the multiple cameras provide an image to the processor which renders a result image showing a result of the processed images. Another conventional approach to imaging includes moving a single image acquisition camera to different positions. Both approaches are costly and require extensive hardware strategically placed for complete viewing. Both approaches are limited by providing images from a single point of view; even in the case of a 180, 360, or 720 degree camera the system is installed so as to have a single viewpoint and cannot be used to view an object from two or more perspectives.

The present invention incorporates these concepts in a series of image acquisition sensors packaged together or separately with digitization, compression and communication components but remotely connected to controllers in a cost-effective configuration. Cost reductions are achieved by reducing manufacturing costs and by reducing installation, mounting, aiming and scene setting costs. The imagers and processor/controller are controlled through wired and wireless communication devices which also acts as a power supply and centralized management.

### SUMMARY OF THE INVENTION

An imaging system is described herein that acquires multiple images from multiple imagers where each are sent to a single processor and controller PanOpts supports multiple processor and controller configurations as well), resulting in the capacity to render single images with controllable multiple points of view and a multiplicity of multi cell image arrays where image layout and image array sequences are under control. The system is comprised of multiple sets of images taken by multiple sensors, strategically placed to acquire multiple perspectives of an image field. Each sensor is packaged with digitization, compression and communication components to allow for the transfer of the image to a processor/controller system controller. The system’s controller acts as the network interface, power supply and centralized management for processing information, specifically the analytics. This PanOpts imaging system as described herein acquires multiple images of a target area, giving it the ability to provide optimal scene (Scenes) creation using multiple point of view and multiple resolutions.

The embodiments of the image acquisition and management system described herein have applications and support applications in surveillance, such as object and people identification and recognition event classification systems, indexed archival storage, real-time and post facto image content analytics, future filtering vectors; ad hoc querying, automatic queries, and multiple query languages. Further, the system provided for the isolation of stored video within and between individual image files.

Further, the PanOpts design can provide infrastructure to manage and communicate signals, messages, and data from these sensors in a more cost-effective method than that currently in use such as individual systems installed by individual vendors, intrusion, file, burglary, Electronic Article Surveillance (EAS), temperature control, people counting, facial recognition, fire, audio, digital signage, etc.

The invention further embodies improved design and component specifications to support image capture, image analytics, image data extraction, extracted image sourced data, image associated data and metadata, sensor subsystem data, as well as system communications. The described system provides design, component specification, fabrication specifications, installation, configuration, implementation and testing instructions for a state-of-the-art image system infrastructure.

### BRIEF DESCRIPTION OF THE DRAWINGS

FIG. 1 is a schematic representation of the image acquisition system overview having a central controller interfaced with independent imagers within existing structures to provide optimal scene creation.

FIG. 2 is a schematic representation of the system architecture showing the camera and sensors communicating through the controller with ethernet access by a VMS system.

FIG. 3 is a schematic representation of a single connect gondola showing a serial connection of multiple cameras.

FIG. 4 is a schematic representation of a pass-through gondola showing ethernee access to the controller.

FIG. 5 is a schematic representation of a sensor bus gondola showing the RS-485 Sensor power bus.

FIG. 6 is a schematic flow diagram depicting the PanOptics Fabrication System

### DETAILED DESCRIPTION

In the following detailed description, numerous specific details are set forth in order to provide a thorough understanding of the present invention. However, well-known methods, procedures, systems, and components have not been described in detail so as not to unnecessarily obscure aspects of the various embodiments.

The present invention describes an image acquisition and management system having components and controllers designed to support surveillance systems, event classification systems, such as object and people identification and recognition systems, indexed archival storage, real-time and post facto image content analytics, future filtering vectors, ad hoc querying, automatic queries, and multiple query languages, along with the analysis of stored video within and between individual image files. The system is designed primarily to be internet protocol (IP) compliant and benefit from installation in or on interior fixtures, fittings, and other surfaces in the interior or exterior of buildings. Accordingly, the PanOpts design is based on the deconstruction of the IP camera whereby separate components are independently installed to best suit an interior room design and area of coverage in a cost-effective installation, having system implementation and certification. PanOpts also includes deconstruction of Video Management Systems so that the required system functions are performed by a distributed hardware platform.

The PanOpts design provides the infrastructure to manage and communicate signals, messages, and data from sensors in a more cost-effective method than that currently available through individual systems installed by individual vendors. These sensors include, but not limited to, the following: intrusion, file, burglary, EAS, temperature control, people counting, facial recognition, fire, audio, digital signage, etc.

In a preferred embodiment, the PanOpts device comprises at least one imager, each imager having image acquisition sensors packaged with digitization, compression and communication components that are connected serially and/or in parallel to controllers.

Another embodiment incorporates the flexibility for installation of the imager where the optimal scene creation is maintained with multiple points of view and multiple resolutions. The imager packaging is readily supported within the existing interior design structures such as walls, ceilings, soffits, moldings, thresholds, etc. Further, the image packaging is readily incorporated into devices, fixtures, fittings, signage, display cases, shelving, lighting etc., either at the manufacturers level or as a fabrication in existing devices.

When installed with and as part of other fittings, fixtures, devices, the need and cost of labor for camera installation along with the camera is eliminated. This cost savings is further obtained with aiming for scene creation. Scene creation, aiming and system configuration in the present invention are performed over network connections without the need for adjustment at the imager. Further, incorporating a high-resolution imager provides raster which supports selection of an area most useful in collecting target information.

In each installation type, the image package has the capacity to be installed in a discrete, unobtrusive, and attractive part of the interior design.

A still further embodiment includes controllers that format the images received from the imagers, processes the images, and optionally adds event classification metadata to be used by upstream processes and applications. Various upstream examples include, but not limited to, JPEG images at high resolution used for event classification, people counting, demographic classification, facial or full body classification and recognition, and/or the state of physical areas or machines, including the state of a selling floor area or the display cases, shelving and end caps.

A still further embodiment incorporates various compressions used in the art, including H264, H265, jpeg 2000 and others at resolutions and frame sizes that are optimized for use. PanOpts supports application of multiple compression formats to a single imager to support multiple downstream processes.

An exemplary use includes, but not limited to, live surveillance on site, either over a network or in the cloud. Compressed streams are processed to include metadata that facilitates and optimizes display renderings for human viewers. These are provided as stitching, arrays, rotation of a point of view. Other aspects may include captions that display data such as people, events, or conditions in the scene using metadata provided by the image system of the present invention, either alone or in combination with other systems such as access control, alarm, POS and other data systems. Compressed streams may further include metadata to facilitate and optimize searches, queries, filters for research, editing, montage creation, evidentiary documentation, and case building. These compressed streams offer optimal system performance support and network security.

The image acquisition components and controllers of the present invention are designed to support ambient non-directed, image collection that collects images that include the maximum area at the most useful resolution to support the listed functions and from the maximum points of view to support the use of multiple images per rendering. Images collected to support deep learning applications where specific values and goals emerge from the data through non-directed searches and reinforcement learning techniques. Image files are formatted to provide maximum image data based on time (or number of frames) to be retained for each purpose. Known methods of raising resolution and number of frames in the sequence can be applied when needed.

The image acquisition system of the present invention is designed as part of architectural design of interior and exterior of buildings to support maximum safety, security and efficient operation of activities that will take place in the building. Aesthetic considerations include discretion, unobtrusiveness, and enhancement of interior design where possible.

One advantage of the image acquisition system in the present invention incorporates the image capture, control and transmission devises into building structures, fixtures, and fittings with connections for power and communications that support full image system configurations and scene design of the installed system without requiring adjustment or re-aiming of the image capture components by an individual user.

Finally, an image management system firmware (controller) and software (computer) are designed to employ images from multiple points of view at multiple frame rates and at resolutions as source data.

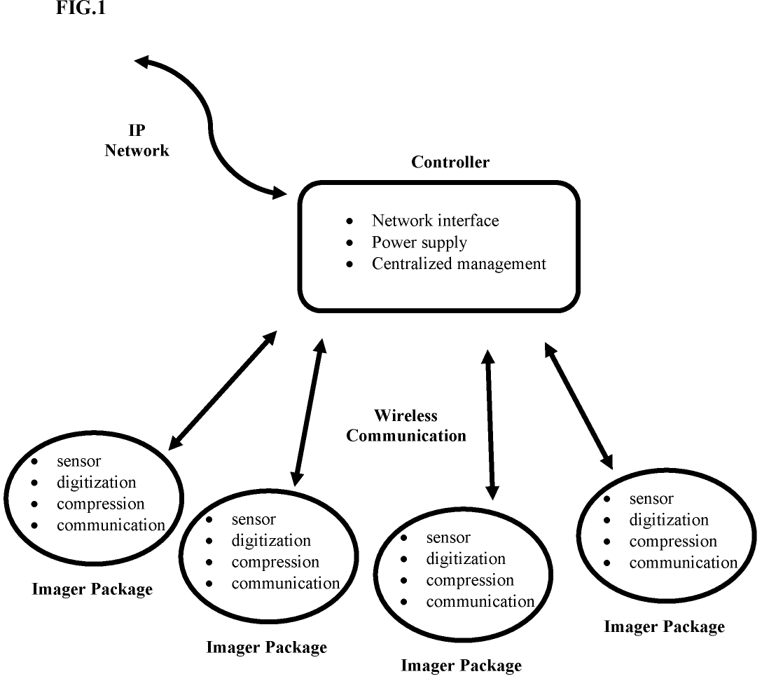

FIG. 1 is an overview of the image acquisition system of the present invention. Independent imagers containing sensors packaged with digitization, compression and communication components are strategically incorporated within the existing interior design structures such as walls, ceilings, soffits, moldings, thresholds. Alternatively, the image packaging is readily incorporated into devices, fixtures, fittings, signage, display cases, shelving, lighting, either at the manufacturers level or as a fabrication in existing devices. Wireless communication to a remotely connected system controller acts as the network interface for the independent imagers, functions as the power supply and provides centralized management. The controller connects the system to an IP network.

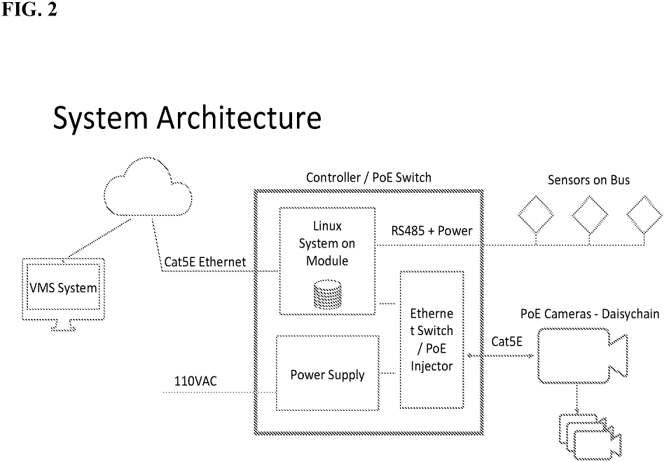

FIG. 2 is a schematic showing one embodiment for the general system architecture and the relationship between the system components. Daisychain cameras are POE enabled so that only the network connection needs to be made. The Power Over Ethernet (PoE) network cables carry electrical power and provide a network connection for the system. A Cat-5e network cabling provides an ethernet connection to the controller of up to 100 MHz and can be used up to a maximum length of 100 meters. The sensors are in a bus having a parallel connection for carrying data and control signals. A controller with a POE switch incorporates a Linux System module for processing input from the sensors through an RS485 network. An Ethernet switch/POE injector interfaces a power supply and module with Linux System. The Cat-5e network provides access to a Video Management System (VMS).

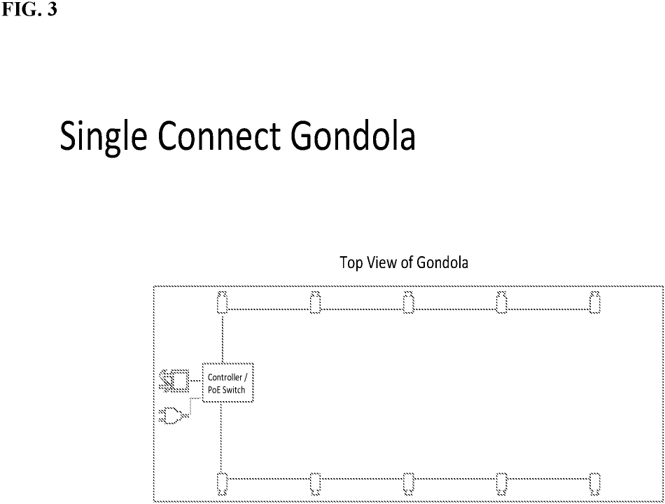

FIG. 3 is a schematic representation of a single connect gondola having a daisychain, parallel arrangement of cameras that feed into the controller.

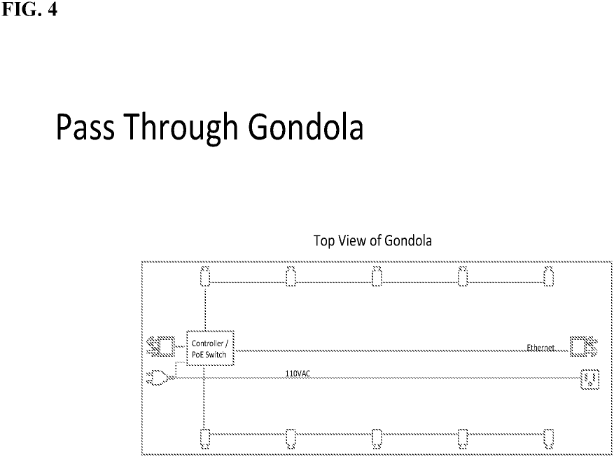

FIG. 4 is a schematic representation of a pass-through gondola showing the daisychain, parallel arrangement of cameras. With a VMS System connected through the Ethernet.

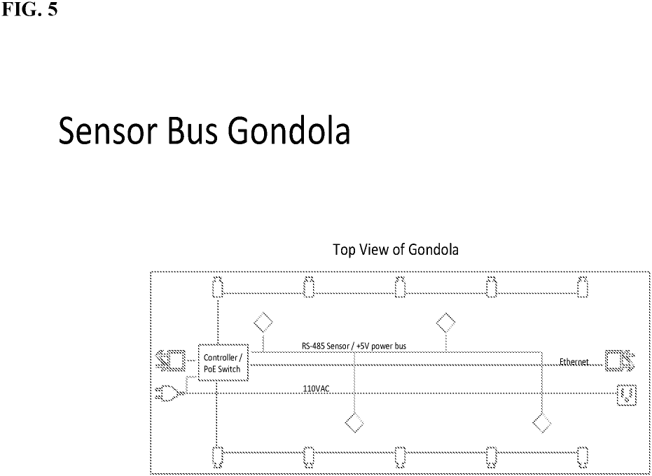

FIG. 5 is a schematic representation of a sensor bus gondola having the the daisychain, parallel arrangement of cameras with a VMS System and a series of senors on a bus connection.

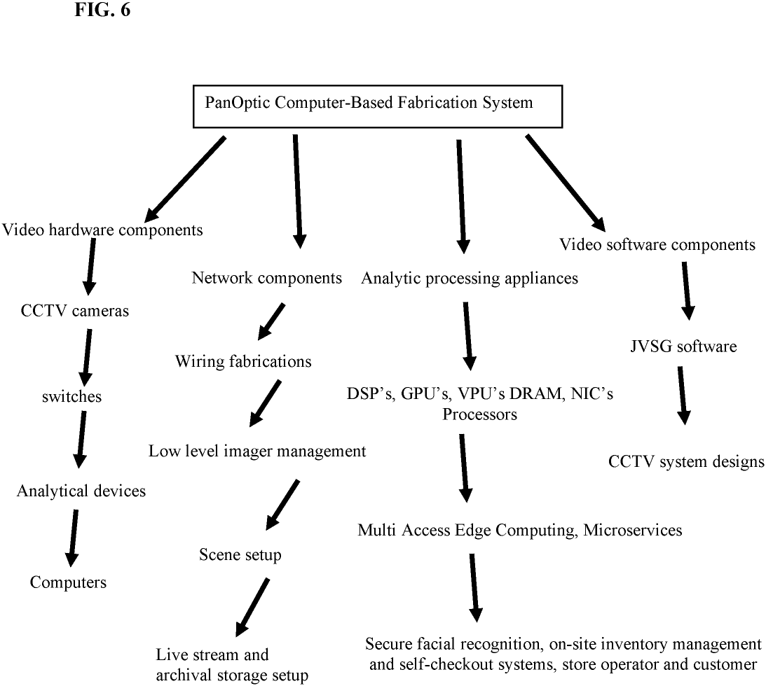

A still further embodiment is disclosed and shown in FIG. 6 which improves upon the PanOptic Computer-Based Fabrication System design and component specifications to support image capture, image analytics, image data extraction, extracted image sourced data, image associated data and metadata, sensor subsystem data, as well as system communications. The described system provides design, component specification, fabrication specifications, installation, configuration, implementation and testing instructions for a state-of-the-art image system infrastructure.

Current state of image system delivery includes CCTV systems that represent the largest proportion of current applications that use image capture as input. Current CCTV systems include IP cameras, Image Processing Appliances, network components and devices, as well as computers and computer peripherals.

In most system implementations, the cameras capture, digitize, and compress the images which are then made available for storage on the camera, and/or transmission over a network to appliances and/or computers.

As specific analytic processes reach a generic stage those processes are moved to an appliance which can support several different generic processes, or to the camera where fewer processes are performed.

At the computer, on site and/or off site, Video Management System software uses the images as input for processes that include:
1. Realtime, live manned surveillance to support real time management and interventions (usually Loss Prevention)
2. Archival storage to support investigations and searches of site-specific operations, activities and events
3. Archival storage to provide objective documentary evidence in civil and criminal cases
4. As live and/or recorded data indexed image and video to be used in conjunction with data captured or imaged from;
   a. Toll and fare collection systems data (EZPASS etc)
   b. Access control and alarm system data (e.g. Brivo )
   c. POS transaction data (StoreCtrl, POSCtrl, Everseen, Stoplift)
   d. Analog display and recording of measurement sensor displays such as humidity or temperature readers
5. Image input for analytic processes [ note; these processes can also be performed in dedicated analytic processing appliances]
   a. Facial, body, and object signature creation
   b. Age, sex, ethnicity signatures where ethnicity signatures are determined by the U.S. Department of Homeland Security for specific ethnic groups.
   c. Alphanumeric character and encoded data readers (License plates, bar codes, QSR, etc.)
   d. People or vehicle counters
   e. Object presence/absence sensing

The majority of system designs and configurations for current CCTV systems include IP cameras, analytic processing appliances (e.g. license plate readers etc.) LAN, WAN switches, POE devices, splitters, routers, monolithic computer and/or Cloud based processes and services.

The labor costs to install and implement IP camera systems include:
1. Services
   a. Development of requirements
      i. list of the physical areas to be covered by image captures
      ii. lists of phenomena including; conditions, circumstances, presence of specific physical items, events, and situations that will require image capture as inputs for applications designed to manage the subjects, purposes, and goals for the image data system
   b. Develop and list individual imager scenes that assure capture of phenomena
   c. Design location and mounting point for each camera to be installed for each scene.
   d. Specify aiming, and lensing for each camera
   e. Produce plans and documentation to support installation of the specified system
   f. Camera selection
      i. Specify camera. CCTV cameras are packaged electronic and optical components in specific configurations designed for marketing requirements. As such they limit and restrict the range of alternatives for mounting, aiming and focus for each scene
      ii. Specify location, lens, packaging, and mounting hardware to support capture of the specific scene. Mounting, lensing, and installation requirements such as wiring constrain this process
   g. Identify network requirements; applications such as live streaming and archival storage are the usual determining factors, but input for analytic processes is becoming more and more important
   h. Specify wiring plan and network infrastructure components and configurations to support system workload
      i. Network requirements identification, design and documentation
      ii. Current designs support two or three streams per camera. Streams service;
         1. Multicamera arrays (chiclets)
         2. Live camera displays
         3. Archival storage
      iii. Cameras are configured to use all available bandwidth as needed. Congestion leads to buffering, robotics, and mosaic effects
   i. Wiring design and documentation
   j. Installation instructions and documentation
   k. Network and power component selection
   l. Network wire and mounting hardware selection
   m. Camera connection to network
   n. Camera configuration for streaming
   o. Camera configuration for recording
   p. System implementation
   q. System test
   r. System certification
   s. System handover and user training
2. Installation labor
   a. Acquire, review, and correct installation documentation
   b. Wiring and network hardware installation
   c. Wire installation,
   d. Wiring, termination and test
   e. System network and power connection
   f. Camera mounting, aiming, focusing
   g. Testing and certification

Installation labor, equipment, management and GNA cost estimates generally average between 35% and 45% of the camera installation cost

The electronic component of the system are:
1. Cameras
2. Switches, network splitters, POE inserters, etc
3. Dedicated Analytic appliances (OCR, License Plate readers, etc.)
4. Computer based monolithic applications processing and storage devices

### Incorporation of Cameras

The cameras, switches, Analytic Devices, computers, and other Video Management hardware components are each packaged to support competitive market pricing for use in systems used for live renderings (surveillance) archival storage, snapshot, as well as video clip searches and retrievals. Cameras are general purpose components and are designed to service multiple applications. At minimum cameras contain all of the components needed to capture, digitize, compress, and provide one or more output streams. They also require packaging, lensing, and mounting hardware. The component selection, firmware, software, lensing, packaging, and mounting hardware used in commercially available cameras, compromise the application to the requirements of the scene and the goals of the image system. The best choice balances the different limitations and represents a compromise that limits image values and applications

### Incorporation of Analytics Appliances

The emerging analytics (motion detection, limited object recognition, tracking, and in limited cases objects e.g. faces, items, products etc.) appliances are also designed and packaged to accommodate a broad range of field applications. The design and fabrication of these components is both limited in scope and/or includes additional non useful resources; the firmware and software are generalized, fixed resources with static updating capacity. Packaging is limited to desktop or rack installations.

### Incorporation of Network Components

The existing network components used in imaging systems consist of packaged appliances that restrict low level configurations to a limited number of points in the network. CCTV camera data outputs spike when scenes include activity and those cameras take the maximum network bandwidth available when required. Current CCTV IP camera system configurations contain, numerous network data flow bottlenecks and deliver poor throughput performance which frequently results in buffering, robotics or mosaic effects. Throughput problems are addressed by implementing configurations with reduced FPS and/or frame size.

### PanOptic Systems Infrastructure Design, Embodiment, Installation, Configuration, Implementation, Test, and Certification

The PanOpts design and PanOpts systems architectures have been developed to improve or eliminate the cost, provide high correlation between the system design and the delivered system;

PanOpts delivered improvements at a lower cost for;
1. system scenes,
2. network performance,
3. data extraction functions.
4. data availability,
5. live display quality,
6. archive reliability,
7. application performance

### PanOptic System Design

The PanOptic design separates the components normally hosted on the camera, networking components (NIC), networking appliances (switch, router, splitter, POE inserter), analytic appliance and distributes and installs them in custom designed fabrications. The PanOptic architecture supports distributing processes, services, and applications to the edge, closer to the inputs, decisions, and outputs. PanOpts designs support fabrication by interior and exterior fixture and fitting companies that supply franchise, generic operations (grocery store gondolas etc.), office buildings, hotels, etc. PanOpts designs can also be fabricated by traditional electronic component contractors. PanOpts leverages the benefits of emerging microelectron, nano electronic, as well as new production technologies such as 3D printing. PanOpts innovations include the following benefits;
1. Installation costs; PanOpts lowers installation costs by orienting and calibrating the imager(s) within the fabrication by design during prior to manufacturing. This reduces the labor to mount and aim individual cameras ( PanOpts also supports multiple imagers in each fabrication). Since the PanOpts system needs no camera mount or mounting, no aiming, no focusing, this lowers installation costs by more than 50%.
2. System design and specification costs; the Panopts architecture supports the use of computer-based tools to design and specify components, packaging (fabrications) wiring, and wiring infrastructure for image and related data systems.
   Software products designed for CCTV systems such as JVSG software, support importing building structure and floor plans in JPEG, PNG, PDF, TIFF or AutoCAD DWG drawings as input for CCTV system designs. There are other tools used for designing purposive spaces e.g. lighting systems, sound systems, retail displays, franchise interiors, human and vehicle traffic management, production floors, shipping/receiving etc. that can provide documentation input for the identification of the imager (and related sensors) placement design and for installation plans for targeted facilities. Of course, expert review, editing, and finalization will still be needed as the creation of a project plan.
   Using the scene, data capture, and physical site requirements for each scene, the designer can specify location, lens, packaging, and mounting hardware to support optimal image captures for each specific scene. Mounting, lensing, and installation requirements are simplified by the PanOpts use of fabrication to fit the specific site. This lowers cost and increases higher correlations between design and delivered systems
3. Design installation project management plan documentation, installation, implementation, test and certification; PanOpts designs for, hardware, firmware and software facilitate accuracy and lower costs at each step of this process. Predictable levels of configuration, calibration, aiming, and lensing reduce errors and time for the entire system delivery process. The computer-based tools add cost effective tools for producing the plan and documentation. Together the emerging tools and PanOpts increase achieving the expected result.
4. Network; PanOpts designs support insertion of network components within the wiring fabrications so as to optimize network management, load balancing, and total system performance. The capacity to modularize the components supports post installation remedial flexibility. PanOpts also supports adding micro service processing into the infrastructure to assure the best performance of the network subsystem through time.
5. Applications; The PanOpts designs adding processors, DSPs, GPUs, VPUs, DRAM, NICs etc. to the fabrications, connectors, and installation hardware to support applications as close to the edge as possible. The design supports Multi Access Edge Computing, Microservices, and other functions such as highly secure facial recognition, on site inventory management, and Self-Checkout system, store operator, and customer services.
6. Configuration; PanOpts supports network-based configuration that includes low level imager management, scene setup, networking, as well live stream and archival storage setup
7. Testing;
8. Certification
9. Documentation for delivered system

While not limiting, these schematic representations show different embodiments for a system architecture.

Although illustrated and described above with reference to certain specific embodiments, the present invention nevertheless is not intended to be limited to the details shown. Rather, various modifications may be made in the details within the scope and range of equivalents of the claims and without departing from the spirit of the invention.

I claim:

1. A PanOptic computer-based fabrication system comprising:
a. video management hardware components;
b. video management software components;
c. analytic processing appliances; and
d. network components,
where a resulting fabrication system supports image capture, image analytics, image data extraction, extracted image sourced data, image associated data and metadata, sensor subsystem data as well as system communications.

2. The fabrication system of claim 1 where the video management hardware components comprises:
a. cameras connected to a network;
b. switches;
c. analytic devices; and
d. computers,
wherein a, b, and c are packaged to support competitive market pricing in systems used for live renderings, archival storage, snapshot, as well as video clip searches and retrievals.

3. The fabrication system of claim 2 where the cameras are CCTV cameras packaged with electronic and optical components in specific configurations to limit the range of alternatives for mounting, aiming and focus of reach specific scenes based on location, mounting, lensing, and installation requirements for wiring constraint.

4. The fabrication system of claim 1 where the video management software components comprises:
a. real time, live manned surveillance software to support real time management and loss prevention interventions;
b. investigation and search archival storage software of site-specific operations, activities and events; and
c. objective documentary evidence archival storage software for civil and criminal legal cases.

5. The fabrication system of claim 4 where the video management software to support importing building components a, b, and c include recorded data indexed image and video captured from toll collection systems data, access control and alarm system data, POS transaction data, and measurement sensor displays.

6. The fabrication system of claim 5 where the sensor display is a humidity or temperature reader.

7. The fabrication system of claim 1 where the software is JFSG software to support importing building structure and floor plans in JPEG, PNG, PDF, TIFF or AutoCAD DWG drawings.

8. The fabrication system of claim 1 where the analytic processing appliances perform processing selected from a group consisting of facial signatures, body signatures, object signatures, age signatures, sex signatures, and ethnicity signatures.

9. The fabrication system of claim 1 where the analytic processing appliances is an alphanumeric character reader or an encoded data reader.

10. The fabrication system of claim 1 where the analytic processing appliances is a counter for sensing the presence of people or vehicles.

11. The fabrication system of claim 1 where the network components include live streaming means and archival storage means having wiring configurations to support more than two streams per camera with multi-camera arrays, or live camera displays.

12. The fabrication system of claim 1 further having wiring design documentation, installation instructions.
